(19) United States
(12) Patent Application Publication
(10) Pub. No.: US 2024/0021838 A1
(43) Pub. Date: Jan. 18, 2024

(54) ELECTROCHEMICAL APPARATUS AND ELECTRONIC APPARATUS

(71) Applicant: Ningde Amperex Technology Limited, Ningde City (CN)

(72) Inventor: Jun Guo, Ningde City (CN)

(73) Assignee: Ningde Amperex Technology Limited, Ningde City (CN)

(21) Appl. No.: 18/371,017

(22) Filed: Sep. 21, 2023

Related U.S. Application Data
(63) Continuation of application No. PCT/CN2021/082146, filed on Mar. 22, 2021.

(51) Int. Cl. H01M 4/66; H01M 4/62

(52) U.S. Cl. CPC H01M 4/663; H01M 4/622; H01M 4/667; H01M 2004/021

(57) ABSTRACT

An electrochemical apparatus includes an electrode plate, where the electrode plate includes a current collector, a first layer, and a second layer. The first layer includes a conductive agent, where the conductive agent has a specific surface area (BET) of 60 m²/g to 1500 m²/g. The second layer includes an active material. The first layer is provided between the current collector and the second layer. The conductive agent having a large specific surface area increases the quantity of conductive network paths constructed per unit area, thereby achieving a better conductive connectivity, reducing electronic resistance of the electrode plate, and improving rate performance and cycling performance of the electrochemical apparatus.

### CROSS REFERENCE TO THE RELATED APPLICATIONS

This application is a continuation under 35 U.S.C. § 120 of international patent application PCT/CN2021/082146 filed on Mar. 22, 2021, the entire content of which is incorporated herein by reference.

### TECHNICAL FIELD

This application relates to the field of electrochemical energy storage, and in particular, to an electrochemical apparatus and an electronic apparatus.

### BACKGROUND

With the development and advancement of electrochemical apparatuses (for example, lithium-ion batteries), increasingly high requirements are imposed on their rate performance, cycling performance, and energy density. Currently, to improve safety performance and cycling performance of an electrochemical apparatus, a primer layer is usually provided between a current collector and an active material layer to enhance an adhesion force between the current collector and the active material layer and to prevent delamination during cycling.

However, the conductivity of the primer layer is usually slightly low, which affects the improvement of the rate performance of the electrochemical apparatus. To enhance the conductivity of the primer layer, the proportion of conductive agent in the primer layer is typically increased, which decreases the proportion of binder in the primer layer, thereby adversely affecting full utilization of adhesion performance of the primer layer. Therefore, further improvements in this regard are expected.

### SUMMARY

Some embodiments of this application provide an electrochemical apparatus. The electrochemical apparatus includes an electrode plate, where the electrode plate includes a current collector, a first layer, and a second layer. The first layer includes a conductive agent, where the conductive agent has a specific surface area (BET) of 60 m²/g to 1500 m²/g. The second layer includes an active material, where the second layer is provided on at least one surface of the current collector, and the first layer is provided between the current collector and the second layer.

In some embodiments, based on a total mass of the first layer, a mass percentage of the conductive agent is 50% to 80%. In some embodiments, a ratio of an orthographic projection area of the first layer on a surface of the current collector to an area of the current collector is 30% to 100%. In some embodiments, the first layer has a surface roughness (Ra) of 0.5 μm to 1.5 μm. In some embodiments, the first layer has a single-side thickness T of 0.2 μm to 1 μm.

In some embodiments, the conductive agent includes at least one of conductive carbon black, Ketjen black, acetylene black, conductive graphite, graphene, carbon nanotubes, or carbon fiber. In some embodiments, the first layer further includes a binder, where the binder includes at least one of polyacrylic acid, polyacrylate, polymethacrylic acid, polyacrylamide, polymethacrylamide, polymethacrylate, polyvinyl alcohol, or sodium alginate. In some embodiments, a median particle size D₅₀ of particles of the conductive agent in the first layer and a thickness T of the first layer satisfy that T is within a range of 2×D₅₀ to 5×D₅₀. In some embodiments, the first layer further includes a dispersant, where the dispersant includes one or both of lithium carboxymethyl cellulose or sodium carboxymethyl cellulose. In some embodiments, the first layer has an areal density of 0.03 mg/cm² to 0.3 mg/cm².

In some embodiments, the binder has a weight-average molecular weight of 10,000 to 500,000. In some embodiments, based on a total mass of the first layer, a mass percentage of the binder is 10% to 48%. In some embodiments, based on a total mass of the first layer, a mass percentage of the dispersant is T % to 10%.

An embodiment of this application further provides an electronic apparatus, including the foregoing electrochemical apparatus.

According to some embodiments of this application, the first layer is provided between the current collector and the second layer, and the first layer includes the conductive agent having a large specific surface area. Such conductive agent having a large specific surface area increases a quantity of conductive network paths constructed per unit area, thereby achieving a better conductive connectivity, reducing electronic resistance of the electrode plate, and improving rate performance and cycling performance of the electrochemical apparatus.

### BRIEF DESCRIPTION OF DRAWINGS

FIGS. 1 and 2 are cross-sectional views of an electrode plate that are taken along planes defined in a thickness direction and width direction of the electrode plate according to some embodiments of this application.

### DETAILED DESCRIPTION

The following embodiments may allow persons skilled in the art to understand this application more comprehensively, but impose no limitation on this application in any manner.

Some embodiments of this application provide an electrochemical apparatus, where the electrochemical apparatus includes an electrode plate. In some embodiments, the electrode plate includes a current collector, a first layer, and a second layer, where the second layer is provided on at least one surface of the current collector, and the first layer is provided between the current collector and the second layer. In some embodiments, the electrode plate may be a positive electrode plate and/or a negative electrode plate. For brevity, the positive electrode plate is described below as an example. It should be understood that the negative electrode plate may have a corresponding structure.

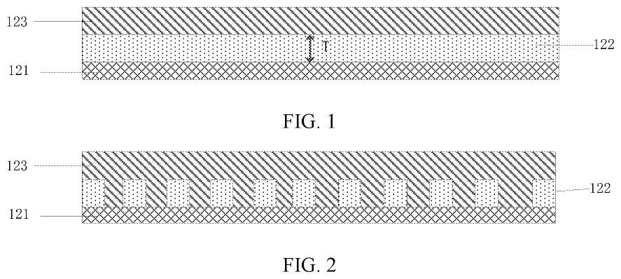

As shown in FIG. 1, the positive electrode plate includes a current collector 121, a first layer 122, and a second layer 123, where the first layer 122 is provided between the current collector 121 and the second layer 123. It should be understood that although the first layer 122 and the second layer 123 are both located on one side of the current collector 121 in FIG. 1, this is only an example, and the first layer 122 and the second layer 123 may be located on two sides of the current collector 121 respectively. In some embodiments, the second layer 123 includes an active material, for example, a positive electrode active material. In some embodiments, the first layer 122 includes a conductive agent, where the conductive agent has a specific surface area (BET) of 60 m²/g to 1500 m²/g. Such conductive agent having a large specific surface area within this range increases a quantity of conductive network paths constructed per unit area in the first layer 122, thereby achieving a better conductive connectivity, reducing electronic resistance of the electrode plate, and improving rate performance and cycling performance of the electrochemical apparatus.

In some embodiments, based on a total mass of the first layer 122, a mass percentage of the conductive agent is 50% to 80%. If the mass percentage of the conductive agent is excessively low, for example, lower than 50%, the conductivity of the first layer 122 is adversely affected. If the mass percentage of the conductive agent is excessively high, for example, higher than 80%, the excessive conductive agent adversely affects adhesion between the first layer 122 and the current collector 121 due to the slightly poor adhesion performance of the conductive agent.

In some embodiments, a ratio of an orthographic projection area of the first layer 122 on a surface of the current collector 121 to an area of the current collector 121 is 30% to 100%. If the ratio of the orthographic projection area of the first layer 122 on the surface of the current collector 121 to the area of the current collector 121 is excessively small, the first layer 122 can make relatively limited improvement in adhesion between the current collector 121 and the second layer 123. Preferably, the ratio of the orthographic projection area of the first layer 122 on the surface of the current collector 121 to the area of the current collector 121 is 50% to 70%. In this case, the roughness of the first layer 122 is improved, a good adhesion effect can be achieved, and the adverse effect on energy density of the electrochemical apparatus can be minimized. As shown in FIG. 2, in some embodiments, the first layer 122 may be linear in a length and/or width direction of the positive electrode plate. In this case, the second layer 123 may be partially in direct contact with the current collector 121. Compared with the first layer 122 as a continuous coating, the discontinuous first layer 122 can increase a contact area and riveting effect between the first layer 122 and the second layer 123, enhancing an adhesion force of the positive electrode plate.

In some embodiments, the first layer 122 has a surface roughness (Ra) of 0.5 μm to 1.5 μm. A relatively large surface roughness (0.5 μm to 1.5 μm) of the first layer 122 is selected to increase the contact area and riveting effect between the first layer 122 and the second layer 123 as well as between the current collector 121 and the first layer 122, enhancing an adhesion force therebetween, thereby improving the stability of a conductive network during cycling of the electrochemical apparatus, and improving the cycling performance of the electrochemical apparatus.

In some embodiments, the first layer 122 has a single-side thickness T of 0.2 μm to 1 μm. An excessively small thickness of the first layer 122 leads to a relatively limited improvement in the adhesion force between the current collector 121 and the second layer 123. An excessively large thickness of the first layer 122 leads to an adverse effect on the energy density of the electrochemical apparatus. The first layer 122 having the single-side thickness T of 0.2 μm to 1 μm can ensure a relatively high energy density of the electrochemical apparatus while improving the rate performance and cycling performance of the electrochemical apparatus. In some embodiments, a median particle size D₅₀ of particles of the conductive agent in the first layer 122 and the thickness T of the first layer 122 satisfy that T is within a range of 2×D₅₀ to 5×D₅₀. In this way, it can be ensured that the first layer 122 has 2 to 5 particles of the conductive agent in a same thickness direction, thereby ensuring effective stacking of the particles of the conductive agent in the first layer 122, and facilitating the construction of the conductive network in the first layer 122. If T is less than 2×D₅₀, it is not conducive to the construction of the conductive network in the thickness direction of the first layer 122. If T is greater than 5×D₅₀, the first layer 122 is excessively thick, which is not conducive to the improvement in the energy density of the electrochemical apparatus.

In some embodiments, the conductive agent may include at least one of conductive carbon black, Ketjen black, acetylene black, conductive graphite, graphene, carbon nanotubes, or carbon fiber. In some embodiments, the first layer 122 may further include a binder, where the binder may include at least one of polyacrylic acid, polyacrylate (for example, sodium polyacrylate or calcium polyacrylate), polymethacrylic acid, polyacrylamide, polymethacrylamide, polymethacrylate, polyvinyl alcohol, or sodium alginate. In some embodiments, the binder has a weight-average molecular weight of 10,000 to 500,000. The binder having the weight-average molecular weight of 10,000 to 500,000 can ensure that the binder is anchored in a form of an anionic dispersant to residual functional groups (for example, carboxyl group/hydroxyl group/phenol group) on surfaces of the particles of the conductive agent, thereby implementing effective dispersion of the conductive agent. If the weight-average molecular weight of the binder is excessively high, for example, greater than 500,000, it is not conducive to the effective dispersion of the conductive agent. In some embodiments, based on a total mass of the first layer 122, a mass percentage of the binder is 10% to 48%. If the mass percentage of the binder is excessively low, it is not conducive to full utilization of adhesion performance of the first layer 122. If the mass percentage of the binder is excessively high, the conductivity of the first layer 122 is adversely affected.

In some embodiments, the first layer 122 further includes a dispersant, where the dispersant includes one or both of lithium carboxymethyl cellulose or sodium carboxymethyl cellulose. In some embodiments, based on a total mass of the first layer 122, a mass percentage of the dispersant is 1% to 10%. If the mass percentage of the dispersant is excessively low, it is not conducive to the utilization of the dispersion effect of the dispersant. If the mass percentage of the dispersant is excessively high, it is not conducive to the improvement in the conductivity of the first layer 122.

In some embodiments, to make the surface roughness of the first layer 122 be 0.5 μm to 1.5 μm and make the single-side thickness T of the first layer 122 be 0.2 μm to 1 μm, the areal density of the first layer 122 is set to be 0.03 mg/cm² to 0.3 mg/cm².

In some embodiments, under the condition that the positive electrode plate includes the foregoing structure, the second layer 123 is a positive electrode active material layer and includes a positive electrode active material. In some embodiments, the positive electrode active material includes at least one of lithium cobalt oxide, lithium iron phosphate, lithium manganese iron phosphate, sodium iron phosphate, lithium vanadium phosphate, sodium vanadium phosphate, lithium vanadyl phosphate, sodium vanadyl phosphate, lithium vanadate, lithium manganate oxide, lithium nicotinate, lithium nickel cobalt manganate, lithium-rich manganese-based material, or lithium nickel cobalt aluminate. In some embodiments, the positive electrode active material layer may further include a conductive agent. In some embodiments, the conductive agent in the positive electrode active material layer may include at least one of conductive carbon black, Ketjen black, laminated graphite, graphene, carbon nanotubes, or carbon fiber. In some embodiments, the positive electrode active material layer may further include a binder. The binder in the positive electrode active material layer may include at least one of carboxymethyl cellulose (CMC), polyacrylic acid, polyvinylpyrrolidone, polyaniline, polyimide, polyamideimide, polysiloxane, styrene-butadiene rubber, epoxy resin, polyester resin, polyurethane resin, or polyfluorene. In some embodiments, a mass ratio of the positive electrode active material, conductive agent, and binder in the positive electrode active material layer may be (80-99):(0.1-10):(0.1-10). In some embodiments, the positive electrode active material layer may have a thickness of 10 μm to 500 μm.

In some embodiments, a current collector of the positive electrode plate may be Al foil, or certainly may be another current collector commonly used in the art. In some embodiments, the current collector of the positive electrode plate may have a thickness of 1 μm to 200 μm. In some embodiments, the positive electrode active material layer may be applied onto only a partial region of the current collector of the positive electrode plate.

In some embodiments, under the condition that the negative electrode plate includes the foregoing structure, the second layer 123 is a negative electrode active material layer. In some embodiments, the negative electrode active material layer includes a negative electrode active material, where the negative electrode active material may include at least one of graphite, hard carbon, silicon, silicon monoxide, or organosilicon. In some embodiments, the negative electrode active material layer may further include a conductive agent and a binder. In some embodiments, the conductive agent in the negative electrode active material layer may include at least one of conductive carbon black, Ketjen black, laminated graphite, graphene, carbon nanotubes, or carbon fiber. In some embodiments, the binder in the negative electrode active material layer may include at least one of carboxymethyl cellulose (CMC), polyacrylic acid, polyvinylpyrrolidone, polyaniline, polyimide, polyamideimide, polysiloxane, styrene-butadiene rubber, epoxy resin, polyester resin, polyurethane resin, or polyfluorene. In some embodiments, a mass ratio of the negative electrode active material, the conductive agent, and the binder in the negative electrode active material layer may be (80-98):(0.1-10):(0.1-10). In some embodiments, a current collector of the negative electrode plate may be at least one of a copper foil, a nickel foil, or a carbon-based current collector.

In some embodiments, an electrode assembly of the electrochemical apparatus may further include a separator disposed between the positive electrode plate and the negative electrode plate. In some embodiments, the separator includes at least one of polyethylene, polypropylene, polyvinylidene fluoride, polyethylene terephthalate, polyimide, or aramid. For example, polyethylene is selected from at least one of high-density polyethylene, low-density polyethylene, or ultra-high molecular weight polyethylene. Especially, polyethylene and polypropylene have a good effect on preventing short circuits and can improve stability of a battery through a shutdown effect. In some embodiments, thickness of the separator is within a range of approximately 5 μm to 500 μm.

In some embodiments, the separator may further include a porous layer on the surface. The porous layer is disposed on at least one surface of a substrate of the separator and includes inorganic particles and a binder, where the inorganic particles are selected from at least one of aluminum oxide (Al₂O₃), silicon dioxide (SiO₂), magnesium oxide (MgO), titanium oxide (TiO₂), hafnium dioxide (HfO₂), stannic oxide (SnO₂), cerium dioxide (CeO₂), nickel oxide (NiO), zinc oxide (ZnO), calcium oxide (CaO), zirconium dioxide (ZrO₂), yttrium oxide (Y₂O₃), silicon carbide (SiC), boehmite, aluminum hydroxide, magnesium hydroxide, calcium hydroxide, or barium sulfate. In some embodiments, pores of the separator have a diameter within a range of approximately 0.01 μm to 1 μm. The binder in the porous layer is selected from at least one of polyvinylidene fluoride, a vinylidene fluoride-hexafluoropropylene copolymer, polyamide, polyacrylonitrile, polyacrylate ester, polyacrylic acid, polyacrylate salt, sodium carboxymethyl cellulose, polyvinylpyrrolidone, polyvinyl ether, polymethyl methacrylate, polytetrafluoroethylene, or polyhexafluoropropylene. The porous layer on the surface of the separator can improve heat resistance, oxidation resistance, and electrolyte infiltration performance of the separator, and enhance adhesion between the separator and the electrode plate.

In some embodiments of this application, the electrode assembly of the electrochemical apparatus is a wound electrode assembly, a laminated electrode assembly, or a folded electrode assembly. In some embodiments, the positive electrode plate and/or negative electrode plate of the electrochemical apparatus may be a multi-layer structure formed through winding or lamination, or may be a single-layer structure formed by stacking a single positive electrode plate, a separator, and a single negative electrode plate.

In some embodiments, the electrochemical apparatus includes a lithium-ion battery but this application is not limited thereto. In some embodiments, the electrochemical apparatus may further include an electrolyte. The electrolyte may be one or more of a gel electrolyte, a solid electrolyte, and an electrolyte solution, and the electrolyte solution includes a lithium salt and a non-aqueous solvent. The lithium salt is selected from one or more of LiPF₆, LiBF₄, LiAsF₆, LiClO₄, LiB(C₆H₅)₄, LiCH₃SO₃, LiCF₃SO₃, LiN(SO₂ CF₃)₂, LiC(SO₂ CF₃)₃, LiSiF₆, LiBOB, or lithium difluoroborate. For example, LiPF₆ is selected as the lithium salt because it has a high ionic conductivity and can improve cycling performance.

The non-aqueous solvent may be a carbonate compound, a carboxylate compound, an ether compound, another organic solvent, or a combination thereof.

The carbonate compound may be a linear carbonate compound, a cyclic carbonate compound, a fluorocarbonate compound, or a combination thereof.

An example of the linear carbonate compound is diethyl carbonate (DEC), dimethyl carbonate (DMC), dipropyl carbonate (DPC), methyl propyl carbonate (MPC), ethyl propyl carbonate (EPC), methyl ethyl carbonate (MEC), and a combination thereof. An example of the cyclic carbonate compound is ethylene carbonate (EC), propylene carbonate (PC), butylene carbonate (BC), vinyl ethylene carbonate (VEC), or a combination thereof. An example of the fluorocarbonate compound is fluoroethylene carbonate (FEC), 1,2-difluoroethylene carbonate, 1,1-difluoroethylene carbonate, 1,1,2-trifluoroethylene carbonate, 1,1,2,2-tetrafluoroethylene carbonate, 1-fluoro-2-methylethylene carbonate, 1-fluoro-1-methylethylene carbonate, 1,2-difluoro-1-methylethylene carbonate, 1,1,2-trifluoro-2-methylethylene carbonate, trifluoromethylethylene carbonate, or a combination thereof.

An example of the carboxylate compound is methyl acetate, ethyl acetate, n-propyl acetate, tert-butyl acetate, methyl propionate, ethyl propionate, propyl propionate, γ-butyrolactone, decanolide, valerolactone, mevalonolactone, caprolactone, methyl formate, or a combination thereof.

An example of the ether compound is dibutyl ether, tetraglyme, diglyme, 1,2-dimethoxyethane, 1,2-diethoxyethane, ethoxymethoxy ethane, 2-methyltetrahydrofuran, tetrahydrofuran, or a combination thereof.

An example of the another organic solvent is dimethyl sulfoxide, 1,2-dioxolane, sulfolane, methyl sulfolane, 1,3-dimethyl-2-imidazolidinone, N-methyl-2-pyrrolidone, formamide, dimethylformamide, acetonitrile, trimethyl phosphate, triethyl phosphate, trioctyl phosphate, phosphate ester, or a combination thereof.

In some embodiments of this application, a lithium-ion battery is used as an example. A positive electrode plate, a separator, and a negative electrode plate are wound or stacked in sequence to form an electrode assembly, and the electrode assembly is then put into, for example, an aluminum-plastic film, followed by electrolyte injection, formation, and packaging, to prepare a lithium-ion battery. Then, a performance test is performed on the prepared lithium-ion battery.

Persons skilled in the art will understand that the method for preparing the electrochemical apparatus (for example, the lithium-ion battery) described above is only an example. Without departing from the content disclosed in this application, other methods commonly used in the art may be used.

An embodiment of this application further provides an electronic apparatus including the foregoing electrochemical apparatus. The electronic apparatus in some embodiments of this application is not particularly limited, and may be any known electronic apparatus used in the prior art. In some embodiments, the electronic apparatus may include but is not limited to a notebook computer, a pen-input computer, a mobile computer, an electronic book player, a portable telephone, a portable fax machine, a portable copier, a portable printer, a stereo headset, a video recorder, a liquid crystal television, a portable cleaner, a portable CD player, a mini-disc, a transceiver, an electronic notepad, a calculator, a memory card, a portable recorder, a radio, a standby power source, a motor, an automobile, a motorcycle, a motor bicycle, a bicycle, a lighting appliance, a toy, a game console, a timepiece, an electric tool, a flash lamp, a camera, a large household battery, and a lithium-ion capacitor.

Some specific examples and comparative examples are listed below to better illustrate this application. Lithium-ion batteries are used as examples. For brevity, only the positive electrode plate including the first layer is used as an example below.

### Example 1

Preparation of positive electrode plate: An aluminum foil was used as a current collector of a positive electrode plate, and a first layer slurry was evenly applied on the surface of the aluminum foil, where the slurry included 65 wt % of conductive carbon black (SP, BET=60 m²/g), 2.4 wt % of sodium carboxymethyl cellulose (CMC-Na), and 32.6 wt % of polyacrylic acid sodium (PAA-Na, with a molecular weight of 300,000); and the slurry was dried to obtain a coating with a single-side thickness of approximately 200 nm (tested using a micrometer). Subsequently, a second layer that is a positive electrode active material layer was applied on the first layer. Specifically, a positive electrode active material lithium iron phosphate, a conductive agent conductive carbon black, and a binder polyacrylic acid were dissolved in an N-methylpyrrolidone (NMP) solution at a weight ratio of 98.2:0.5:1.3 to form a positive electrode active material layer slurry, and the slurry was applied on the first layer to obtain a positive electrode active material layer, followed by drying, cold pressing, and cutting to obtain the positive electrode plate.

Preparation of negative electrode plate: Graphite, sodium carboxymethyl cellulose (CMC-Na), and a binder styrene-butadiene rubber were dissolved in deionized water at a weight ratio of 97.8:1.3:0.9 to form a negative electrode slurry. A copper foil with a thickness of 10 μm was used as a current collector of a negative electrode plate, and the negative electrode slurry was applied on the current collector of the negative electrode plate, followed by drying and cutting to obtain the negative electrode plate.

Preparation of separator: Polyethylene (PE) with a thickness of 8 μm was used as a separator substrate, two sides of the separator substrate were each coated with a 2 μm aluminum oxide ceramic layer, and ultimately two sides of the ceramic layer were each coated with a 2.5 mg binder polyvinylidene fluoride (PVDF), followed by drying.

Preparation of electrolyte: Under an atmosphere with a water content less than 10 ppm, LiPF₆ was added to a non-aqueous organic solvent (in which ethylene carbonate (EC) and propylene carbonate (PC) were at a weight ratio of 50:50), where a concentration of LiPF₆ was 1.15 mol/L; and the solution was well mixed to obtain an electrolyte.

Preparation of lithium-ion battery: The positive electrode plate, the separator, and the negative electrode plate were stacked in sequence, so that the separator was sandwiched between the positive electrode plate and the negative electrode plate for separation, and the resulting stack was wound to obtain an electrode assembly. The electrode assembly was placed in an outer packaging aluminum-plastic film, and after water removal was performed at 80° C., the electrolyte was injected and packaged, followed by processes such as formation, degassing, and trimming to obtain a lithium-ion battery.

For examples and comparative examples, parameters were changed based on the steps in example 1 or 2. Specific parameters changed are shown in the following tables.

In examples 2 and 3 and comparative example 1, the specific surface area of the conductive agent of the first layer was different from that of example 1.

In examples 4 to 8, the mass percentages of the components in the first layer were different from those of example 2.

In examples 9 to 14, the ratio of the orthographic projection area of the first layer on the surface of the current collector to the area of the current collector was different from that of example 2.

In examples 15 to 19, the surface roughness of the first layer was different from that of example 2.

In examples 20 to 23, the thickness and areal density of the first layer were different from those of example 2.

In examples 24 to 26, the thickness of the first layer and D₅₀ of the conductive agent were different from those of example 2.

In examples 27 to 31, the weight-average molecular weight of the binder in the first layer was different from that of example 2.

The following describes methods for testing the parameters of this application.

Test Method for Coverage

A battery was disassembled to obtain a positive electrode plate (which included a current collector, a first layer, and a second layer), and the electrode plate was soaked for 30 min using a dimethyl carbonate (DMC) solvent and then washed to remove an electrolyte, and the electrode plate was soaked and washed repeatedly for three times. Then, the positive electrode plate was naturally air-dried. For the air-dried electrode plate, the second layer was peeled off using an adhesive tape (or the electrode plate was soaked for 30 min using N-methyl pyrrolidone (NMP), washed to remove the second layer, and then dried), and the electrode plate with the current collector and the first layer was obtained. Then, the electrode plate including the first layer was cut into samples with length×width=40 mm×20 mm using a Der Herng DHTW-15 sampling and cutting table. The samples were placed flatly between two glass sheets (the glass sheets were each in length×width=60 mm×40 mm, clean and scratch-free), gently pressed to flatten, and then photographed using an optical microscope at a magnification of 50×. A coverage of the first layer (that is, a ratio of an orthographic projection area of the first layer on a surface of the current collector to an area of the current collector) was automatically analyzed using VHX-5000 analysis software. Five parallel samples were tested, and an average was found.

Test Method for Roughness

A battery was disassembled to obtain a positive electrode plate (which included a current collector, a first layer, and a second layer), and the electrode plate was soaked for 30 min using a dimethyl carbonate (DMC) solvent and then washed to remove an electrolyte, and the electrode plate was soaked and washed repeatedly for three times. Then, the positive electrode plate was naturally air-dried. For the air-dried electrode plate, the second layer was peeled off using an adhesive tape (or the electrode plate was soaked for 30 min using N-methyl pyrrolidone (NMP), washed to remove the second layer, and then dried), and the electrode plate with the current collector and the first layer was obtained. Then, the electrode plate including the first layer was cut into samples with length×width=40 mm×20 mm using the Der Herng DHTW-15 sampling and cutting table. Two round glass sheets with a round hole (which had a diameter of 20 mm) in the center were used, and a sample was sandwiched between the two glass sheets, where the center of the sample was located at the center of the round hole to avoid sample wrinkles. The sample was photographed using a VK-X100/200 Series laser microscope in a 100× automatic mode. Then, VK software was used to analyze roughness Ra of a plane with a size of 1 m², in accordance with definitions in the national standard GB/T1031-1995 Surface Roughness Parameters and Their Values.

Test Method for BET of Conductive Agent

A battery was disassembled to obtain a positive electrode plate (which included a current collector, a first layer, and a second layer), and the electrode plate was soaked for 30 min using a dimethyl carbonate (DMC) solvent and then washed to remove an electrolyte, and the electrode plate was soaked and washed repeatedly for three times. Then, the positive electrode plate was naturally air-dried. For the air-dried electrode plate, the second layer was peeled off using an adhesive tape (or the electrode plate was soaked for 30 min using N-methyl pyrrolidone (NMP), washed to remove the second layer, and then dried), and the electrode plate with the current collector and the first layer was obtained. Then, the electrode plate including the first layer was cut into a total of 20 samples with length×width=40 mm×20 mm using the Der Herng DHTW-15 sampling and cutting table. Then 10 samples were put into a clean 500 mL beaker, 200 g of deionized water was added, and the samples were soaked for 1 h, then the samples were clamped by tweezers and washed, and aluminum foils were fished out in turn to obtain a slurry. The slurry in the beaker was dispersed using an ultrasonic cleaning machine (with a frequency of 10 Hz) for 1 h, and then the slurry was poured into a centrifuge tube and centrifuged using a centrifuge (with a rotation speed of 4000 rpm and time of 30 min); and supernatant liquid was taken, ultrasonically dispersed, then filtered using a piece of 0.5 μm filter paper, and washed with NMP repeatedly for 5 times. Then, a solid sample obtained from the surface of the filter paper was put into an oven and roasted at 100° C. for 30 min to obtain powder, and BET of the powder was tested using a Micromeritics TriStar II 3020 device.

Resistance Test of First Layer or Electrode Plate

A battery was disassembled to obtain a positive electrode plate (which included a current collector, a first layer, and a second layer), and the electrode plate was soaked for 30 min using a dimethyl carbonate (DMC) solvent and then washed to remove an electrolyte, and the electrode plate was soaked and washed repeatedly for three times. Then, the positive electrode plate was naturally air-dried. For the air-dried electrode plate (when resistance of the first layers was tested, the second layer was peeled off using an adhesive tape to obtain the electrode plate with the current collector and the first layer), the electrode plate was cut into samples with length×width=100 mm×50 mm using the Der Herng DHTW-15 sampling and cutting table. Data acquisition was performed using a HIOKI BT3562 resistance meter, where a diameter of a contact copper post was 14 mm, a test pressure was 25 MPa (0.4 t), and a data acquisition time was 15 s. A sample was placed between two copper posts, and a switch was pressed to test resistance between the electrode plates or between the first layers. Test principle: An alternating current four-terminal test method was used, an alternating current Is was applied to an object under test, a sensor was used to collect voltage drop Vis caused by the object under test, and corresponding resistance R was deduced according to the Ohm's law.

Test procedures for direct-current resistance DCR were as follows:
(1) A battery was left standing for 4 h in a 25° C. cryostat.
(2) The battery was charged to 3.65 V at a constant current of 0.7 C (that is, a current of a theoretical capacity was fully discharged in 2 h), charged to 0.02 C at a constant voltage of 3.65 V, and left standing for 10 min.
(3) The battery was discharged to 2.5 V at 0.1 C and left standing for 5 min (an actual capacity was obtained in this step).

Test for DCR at 25° C.
(4) After left standing for 5 min, the battery was charged to 3.65 V at a constant current of 0.7 C, and then charged to 0.02 C at a constant voltage of 3.65 V (the actual capacity obtained in step 3 was used for calculation).
(5) The battery was left standing for 10 min.
(6) The battery was discharged for 3 h at 0.1 C (the actual capacity obtained in step 3 was used for calculation to obtain a 70% state of charge (SOC) (remaining capacity of the battery) DCR).

Adhesion Force Test

A battery was disassembled to obtain a positive electrode plate (which included a current collector, a first layer, and a second layer), and the electrode plate was soaked for 30 min using a dimethyl carbonate (DMC) solvent and then washed to remove an electrolyte, and the electrode plate was soaked and washed repeatedly for three times. Then, the positive electrode plate was naturally air-dried. The air-dried electrode plate was cut into samples with length×width=70 mm×20 mm using the Der Herng DHTW-15 sampling and cutting table. Then, a double-sided tape with length×width=50 mm×30 mm was tightly attached and securely bonded onto a surface of a stainless steel plate (for which length×width=100 mm×40 mm, and the surface is smooth and clean). Then, the sample was attached onto the double-sided tape, with a reserved length of 20 mm. A long-strip cardboard cut with length×width=100 mm×20 mm was wrapped and bonded with the reserved 20 mm sample using a masking tape. Then, a 2 Kg roller was used to roll the sample twice at a portion with a length of 50 mm where the sample was bonded to the double-sided tape to complete production of a test sample. A 90° tensile test was performed on the produced sample using an Instron 3365 universal tensile testing machine and fixtures. A stable section of a tensile curve was determined as an electrode plate adhesion force between the first layer and the second layer, with adhesion force F=tensile force f (N)/sample width (m). For a test method, reference is made to the national standard GB/T2791-1995 Adhesive T Peel Strength Test Method.

Test for Discharge Capacity Retention Rate at 2 C

The lithium-ion battery was left standing for 2 hours in a thermostat at 25° C.±2° C., charged to 3.65 V at a rate of 0.5 C, and then charged to 0.02 C at a constant voltage of 3.65 V. Then, the lithium-ion battery was left standing for 1.5 hours, discharged to 2.5 V at a rate of 0.2 C for cycling performance test to obtain a reference discharge capacity, and discharged to 2.5 V at a rate of 2 C for cycling performance test to obtain an actual discharge capacity, with discharge capacity retention rate at 2 C=actual discharge capacity/reference discharge capacity×100%.

Cycling Performance Test

The lithium-ion battery was left standing for 2 hours in a thermostat at 25° C.±2° C. or 45° C.±2° C., charged to 3.65 V at a rate of 1 C, and then charged to 0.05 C at a constant voltage of 3.65 V. Then, the lithium-ion battery was discharged to 2.5 V at a rate of 1 C for cycling performance test. A ratio of a capacity after 500 cycles of the lithium-ion battery to an initial capacity was a cycling capacity retention rate.

Parameters and evaluation results of examples 1 to 3 and comparative example 1 are shown in Table 1 and Table 2 respectively.

TABLE 1

| | | | | | | Ratio of | | | | | |
|---|---|---|---|---|---|---|---|---|---|---|---|
| | | | Mass | | | orthographic | | | | | Weight- |
| | | BET of | percent- | Mass | Mass | projection | | | D₅₀ of | | average |
| | Type of | conductive | age of | percent- | percent- | area of | Surface | Thick- | conductive | Areal | molecular |
| | conductive | agent in | conductive | age of | age of | first layer | roughness of | ness of | agent in | density of | weight of |
| | agent in | first layer | agent in | binder in | dispersant in | on surface | first layer | first layer | first layer | first layer | binder in |
| Example | first layer | (m²/g) | [symbol] | first layer | first [symbol] | of current | (Ra, [symbol] ) | (μm) | ( [symbol] ) | (mg/cm²) | first layer |
| 1 | Carbon | 60 | 65% | 30% | 5% | 60% | 1.0 | 0.5 | 0.15 | 0.15 | 300,000 |
| | black | | | | | | | | | | |
| 2 | Acetylene | 300 | 65% | 30% | 5% | 60% | 1.0 | 0.5 | 0.15 | 0.15 | 300,000 |
| | black | | | | | | | | | | |
| 3 | Ketjen | 1500 | 65% | 30% | 5% | 60% | 1.0 | 0.5 | 0.15 | 0.15 | 300,000 |
| | black | | | | | | | | | | |

Comparative example

| | | | | | | | | | | | |
|---|---|---|---|---|---|---|---|---|---|---|---|
| 1 | Carbon | 50 | 65% | 30% | 5% | 60% | 1.0 | 0.5 | 0.15 | 0.15 | 300,000 |
| | black | | | | | | | | | | |

[symbol]

indicates data missing or illegible when filed

TABLE 2

| | | | | | | Capacity | Capacity |
|---|---|---|---|---|---|---|---|
| | | | Adhesion | | Discharge | retention | retention |
| | Resistance | Resistance | force of | | capacity | rate after | rate after |
| | of first | of electrode | electrode | DCR at | retention | 500 cycles | 500 cycles |
| | layer | plate | plate | 25° C. | rate at 2 C | at 1 C/1 C | at 1 C/1 C |
| Example | (Ohm) | (Ohm) | (N/m) | (70% SOC) | (%) | at 25° C. | at 45° C. |
| 1 | 0.0097 | 1.52 | 14 | 35.0 | 97.8% | 94.2% | 92.5% |
| 2 | 0.0086 | 1.35 | 16 | 34.5 | 98.2% | 94.8% | 92.9% |
| 3 | 0.0073 | 1.08 | 16 | 33.5 | 98.8% | 95.5% | 93.5% |

Comparative example

| | | | | | | | |
|---|---|---|---|---|---|---|---|
| 1 | 0.0108 | 1.62 | 4 | 36.3 | 97.2% | 93.3% | 91.5% |

It can be learned from comparison between examples 1 to 3 and comparative example 1 that for the conductive agent having a specific surface area of 60 m²/g to 1500 m²/g, as compared with a case in which the specific surface area is less than 60 m²/g, both the resistance of the first layer and the resistance of the electrode plate decrease, the adhesion force of the electrode plate increases, the direct-current resistance of the electrochemical apparatus decreases, and the rate performance and cycling capacity retention rate of the electrochemical apparatus are improved. In addition, under the condition that the specific surface area of the conductive agent is excessively large, for example, greater than 1500 m²/g, there are more defects in the particles of the conductive agent, and the capability of constructing the conductive network is poor, which is not conducive to utilization of the overall performance of the electrochemical apparatus. Resistance of electrode plate

It can be learned from comparison of examples 1 to 3 that as the specific surface area of the conductive agent in the first layer increases, the resistance of the first layer decreases, the resistance of the electrode plate decreases, the adhesion force of the positive electrode plate increases first and then remains stable, the direct-current resistance of the electrochemical apparatus decreases, the rate performance is improved, and the cycling capacity retention rate increases. This is because the increase in specific surface area of the conductive agent of the first layer helps the conductive agent in the first layer to construct the conductive network, improving the conductivity of the first layer, thereby reducing the sheet resistance of the electrode plate, and improving the kinetic performance and cycling performance of the electrochemical apparatus.

Parameters and evaluation results of examples 4 to 31 are shown in Table 3 and Table 4 respectively.

TABLE 3

| | | | | | | Ratio of | | | | | |
|---|---|---|---|---|---|---|---|---|---|---|---|
| | | | | | | orthographic | | | | | |
| | | | Mass | | | projection | | | | | Weight- |
| | | BET of | percent- | Mass | Mass | area of | | | D₅₀ of | | average |
| | Type of | conductive | age of | percent- | percent- | first layer | Surface | Thick- | conductive | Areal | molecular |
| | conductive | agent in | conductive | age of | age of | on surface | roughness of | ness of | agent in | density of | weight of |
| | agent in | first layer | agent in | binder in | dispersant in | of current | first layer | first layer | first layer | first layer | binder in |
| Example | first layer | (m²/g) | first layer | first [symbol] | first [symbol] | [symbol] | (Ra, [symbol] ) | (μm) | ( [symbol] ) | (mg/cm²) | first layer |
| 4 | Acetylene | 300 | 50% | 48% | 2% | 60% | 1.0 | 0.5 | 0.15 | 0.15 | 300,000 |
| | black | | | | | | | | | | |
| 5 | Acetylene | 300 | 45% | 48% | 7% | 60% | 1.0 | 0.5 | 0.15 | 0.15 | 300,000 |
| | black | | | | | | | | | | |
| 6 | Acetylene | 300 | 85% | 30% | 5% | 60% | 1.0 | 0.5 | 0.15 | 0.15 | 300,000 |
| | black | | | | | | | | | | |
| 7 | Acetylene | 300 | 65% | 34% | 1% | 60% | 1.0 | 0.5 | 0.15 | 0.15 | 300,000 |
| | black | | | | | | | | | | |
| 8 | Acetylene | 300 | 80% | 10% | 10% | 60% | 1.0 | 0.5 | 0.15 | 0.15 | 300,000 |
| | black | | | | | | | | | | |
| 9 | Acetylene | 300 | 65% | 30% | 5% | 30% | 1.0 | 0.5 | 0.15 | 0.09 | 300,000 |
| | black | | | | | | | | | | |
| 10 | Acetylene | 300 | 65% | 30% | 5% | 40% | 1.0 | 0.5 | 0.15 | 0.11 | 300,000 |
| | black | | | | | | | | | | |
| 11 | Acetylene | 300 | 65% | 30% | 5% | 25% | 1.0 | 0.5 | 0.15 | 0.08 | 300,000 |
| | black | | | | | | | | | | |
| 12 | Acetylene | 300 | 65% | 30% | 5% | 100% | 1.0 | 0.5 | 0.15 | 0.18 | 300,000 |
| | black | | | | | | | | | | |
| 13 | Acetylene | 300 | 65% | 30% | 5% | 60% | 1.0 | 0.5 | 0.15 | 0.15 | 300,000 |
| | black | | | | | | | | | | |
| 14 | Acetylene | 300 | 65% | 30% | 5% | 90% | 1.0 | 0.5 | 0.15 | 0.17 | 300,000 |
| | black | | | | | | | | | | |
| 15 | Acetylene | 300 | 65% | 30% | 5% | 60% | 0.5 | 0.5 | 0.15 | 0.15 | 300,000 |
| | black | | | | | | | | | | |
| 16 | Acetylene | 300 | 65% | 30% | 5% | 60% | 0.4 | 0.5 | 0.15 | 0.15 | 300,000 |
| | black | | | | | | | | | | |
| 17 | Acetylene | 300 | 65% | 30% | 5% | 60% | 1.6 | 1.2 | 0.15 | 0.15 | 300,000 |
| | black | | | | | | | | | | |
| 18 | Acetylene | 300 | 65% | 30% | 5% | 60% | 1.0 | 0.8 | 0.15 | 0.15 | 300,000 |
| | black | | | | | | | | | | |
| 19 | Acetylene | 300 | 65% | 30% | 5% | 60% | 1.5 | 1.0 | 0.15 | 0.15 | 300,000 |
| | black | | | | | | | | | | |
| 20 | Acetylene | 300 | 65% | 30% | 5% | 60% | 1.0 | 0.2 | 0.15 | 0.03 | 300,000 |
| | black | | | | | | | | | | |
| 21 | Acetylene | 300 | 65% | 30% | 5% | 60% | 1.0 | 1 | 0.15 | 0.30 | 300,000 |
| | black | | | | | | | | | | |
| 22 | Acetylene | 300 | 65% | 30% | 5% | 60% | 1.0 | 0.5 | 0.15 | 0.15 | 300,000 |
| | black | | | | | | | | | | |
| 23 | Acetylene | 300 | 65% | 30% | 5% | 60% | 1.0 | 0.9 | 0.15 | 0.25 | 300,000 |
| | black | | | | | | | | | | |
| 24 | Ketjen | 1500 | 65% | 30% | 5% | 60% | 1.0 | 0.25 | 0.05 | 0.03 | 300,000 |
| | black | | | | | | | | | | |
| 25 | Ketjen | 1500 | 65% | 30% | 5% | 60% | 1.0 | 0.80 | 0.30 | 0.20 | 300,000 |
| | black | | | | | | | | | | |
| 26 | Ketjen | 1500 | 65% | 30% | 5% | 60% | 1.0 | 1.00 | 0.50 | 0.30 | 300,000 |
| | black | | | | | | | | | | |
| 27 | Acetylene | 300 | 65% | 30% | 5% | 60% | 1.0 | 0.5 | 0.15 | 0.15 | 8,000 |
| | black | | | | | | | | | | |
| 28 | Acetylene | 300 | 65% | 30% | 5% | 60% | 1.0 | 0.5 | 0.15 | 0.15 | 10,000 |
| | black | | | | | | | | | | |
| 29 | Acetylene | 300 | 65% | 30% | 5% | 60% | 1.0 | 0.5 | 0.10 | 0.15 | 300,000 |
| | black | | | | | | | | | | |
| 30 | Acetylene | 300 | 65% | 30% | 5% | 60% | 1.0 | 0.5 | 0.15 | 0.15 | 500,000 |
| | black | | | | | | | | | | |
| 31 | Acetylene | 300 | 65% | 30% | 5% | 60% | 1.0 | 1.5 | 1.20 | 0.35 | 600,000 |
| | black | | | | | | | | | | |

[symbol]

indicates data missing or illegible when filed

TABLE 4

| | | | | | | Capacity | Capacity |
|---|---|---|---|---|---|---|---|
| | | | Adhesion | | Discharge | retention | retention |
| | Resistance | Resistance | force of | | capacity | rate after | rate after |
| | of first | of electrode | electrode | DCR at | retention | 500 cycles | 500 cycles |
| | layer | plate | plate | 25° C. | rate at 2 C | at 1 C/1 C | at 1 C/1 C |
| Example | (Ohm) | (Ohm) | (N/m) | (70% SOC) | (%) | at 25° C. | at 45° C. |
| 4 | 0.0093 | 1.47 | 14 | 34.5 | 98.0% | 94.6% | 92.7% |
| 5 | 0.0102 | 1.55 | 15 | 35.5 | 97.5% | 93.5% | 92.0% |
| 6 | 0.0083 | 1.30 | 9 | 34.8 | 98.0% | 93.8% | 92.1% |
| 7 | 0.0086 | 1.35 | 15 | 34.5 | 98.2% | 94.8% | 92.9% |
| 8 | 0.0090 | 1.32 | 15 | 34.5 | 98.2% | 94.9% | 93.0% |
| 9 | 0.0105 | 1.58 | 10 | 41.5 | 96.5% | 93.0% | 89.0% |
| 10 | 0.0092 | 1.38 | 13 | 34.7 | 98.0% | 94.6% | 92.6% |
| 11 | 0.0073 | 1.60 | 8 | 35.8 | 97.3% | 93.5% | 91.8% |
| 12 | 0.0083 | 1.30 | 16 | 34.2 | 98.3% | 94.8% | 92.9% |
| 13 | 0.0086 | 1.35 | 15 | 34.3 | 98.2% | 94.8% | 92.9% |
| 14 | 0.0086 | 1.35 | 15 | 34.3 | 98.2% | 94.9% | 92.8% |
| 15 | 0.0086 | 1.36 | 11 | 34.4 | 98.1% | 94.6% | 92.6% |
| 16 | 0.085 | 1.34 | 8 | 35.0 | 97.5% | 93.6% | 92.0% |
| 17 | 0.088 | 1.37 | 20 | 34.8 | 97.3% | 93.4% | 92.1% |
| 18 | 0.0087 | 1.35 | 15 | 34.5 | 98.2% | 94.9% | 93.2% |
| 19 | 0.0086 | 1.37 | 20 | 34.5 | 98.2% | 95.0% | 93.3% |
| 20 | 0.0095 | 1.42 | 13 | 34.9 | 97.8% | 94.1% | 92.3% |
| 21 | 0.0081 | 1.32 | 15 | 34.3 | 98.1% | 94.8% | 92.8% |
| 22 | 0.0086 | 1.35 | 14 | 34.5 | 98.2% | 94.8% | 92.9% |
| 23 | 0.0082 | 1.33 | 14 | 34.4 | 98.1% | 94.9% | 92.8% |
| 24 | 0.0068 | 1.02 | 14 | 33.0 | 98.9% | 95.7% | 93.8% |
| 25 | 0.0072 | 1.05 | 16 | 33.2 | 98.7% | 95.3% | 93.5% |
| 26 | 0.0076 | 1.03 | 15 | 33.3 | 98.7% | 95.6% | 93.6% |
| 27 | / | / | Excessively | / | / | / | / |
| | | | poor | | | | |
| | | | adhesion | | | | |
| 28 | 0.0083 | 1.36 | 10 | 34.1 | 98.3% | 94.8% | 92.8% |
| 29 | 0.0086 | 1.35 | 15 | 34.3 | 98.2% | 94.8% | 92.9% |
| 30 | 0.0085 | 1.38 | 16 | 34.3 | 98.2% | 94.7% | 92.7% |
| 31 | 0.0105 | 1.59 | 18 | 36.2 | 97.2% | 93.4% | 91.9% |

“/” indicates that the data cannot be measured.

It can be learned from comparison of examples 4 to 8 that under the condition that the mass percentage of the conductive agent in the first layer is 50% to 80%, as the mass percentage of the conductive agent in the first layer increases, the resistance of the first layer and the resistance of the electrode plate have a trend to decrease, the adhesion force of the positive electrode plate and the direct-current resistance of the electrochemical apparatus have little change, and the rate performance and cycling capacity retention rate of the electrochemical apparatus have a trend to increase. When the mass percentage of the conductive agent in the first layer is excessively low (example 5), the resistance of the first layer and the resistance of the electrode plate increase, and the rate performance and the cycling capacity retention rate of the electrochemical apparatus decrease. When the mass percentage of the conductive agent in the first layer is excessively high (example 6), the adhesion force of the electrode plate decreases.

It can be learned from comparison of examples 9 to 14 that as the ratio of the orthographic projection area of the first layer on the surface of the current collector to the area of the current collector increases, the resistance of the first layer decreases, the resistance of the electrode plate decreases, the adhesion force of the positive electrode plate increases, the direct-current resistance of the electrochemical apparatus decreases, the rate performance is improved, and the cycling capacity retention rate increases. When the ratio of the orthographic projection area of the first layer on the surface of the current collector to the area of the current collector is lower than 30% (example 11), it is not conducive to adhesion and electrical conduction of the first layer and the second layer, resulting in impossible full utilization of the rate performance and cycling performance of the electrochemical apparatus.

It can be learned from comparison of examples 15 to 19 that under the condition that the surface roughness is 0.5 μm to 1.5 μm, as the surface roughness of the first layer increases, the resistance of the first layer and the resistance of the electrode plate have little change, the adhesion force of the positive electrode plate increases, the direct-current resistance of the electrochemical apparatus has little change, and the rate performance and cycling capacity retention rate of the electrochemical apparatus are improved. When the surface roughness of the first layer is excessively large (example 17), the first layer has a risk of being ultra-thick, which is not conducive to the increase of energy density; and when the surface roughness of the first layer is excessively small (example 17), the adhesion force between the first layer and the second layer decreases.

It can be learned from comparison of examples 20 to 23 that as the thickness of the first layer increases, the resistance of the first layer and the resistance of the electrode plate have a trend to decrease, the adhesion force of the positive electrode plate has little change, the direct-current resistance of the electrochemical apparatus has a trend to decrease, and the rate performance and cycling capacity retention rate of the electrochemical apparatus are improved. However, if the thickness of the first layer is excessively large, it is not conducive to the increase of the energy density of the electrochemical apparatus.

It can be learned from comparison of examples 24 to 26 that under the condition that the ratio of the thickness of the first layer to D₅₀ of the conductive agent is within a range of 2 to 5, as the ratio of the thickness of the first layer to D₅₀ of the conductive agent decreases, the resistance of the first layer decreases, the resistance of the electrode plate increases first and then decreases, and the adhesion force of the electrode plate and the direct-current resistance, rate performance, and cycling capacity retention rate of the electrochemical apparatus have little change.

It can be learned from comparison of examples 27 to 31 that under the condition that the weight-average molecular weight of the binder is 10,000 to 500,000, as the weight-average molecular weight of the binder increases, the resistance of the first layer and the resistance of the electrode plate have a trend to increase, and the adhesion force of the electrode plate and the direct-current resistance, rate performance, and cycling capacity retention rate of the electrochemical apparatus have little change. When the weight-average molecular weight of the binder is excessively low (example 27), the adhesion force of the electrode plate is excessively weak; when the weight-average molecular weight of the binder is excessively high (example 31), the resistance of the first layer and the resistance of the electrode plate increase, the direct-current resistance of the electrochemical apparatus increases, and the rate performance and cycling capacity retention rate of the electrochemical apparatus decrease.

The foregoing descriptions are only preferred examples of this application and illustrations of the technical principles used. Persons skilled in the art should understand that the scope of disclosure involved in this application is not limited to the technical solutions resulting from specific combinations of the foregoing technical features, but should also cover other technical solutions resulting from any combinations of the foregoing technical features or their equivalent features, for example, technical solutions resulting from replacement between the foregoing features and technical features having similar functions disclosed in this application.

What is claimed is:

1. An electrochemical apparatus, comprising an electrode plate, wherein the electrode plate comprises:
a current collector;
a first layer comprising a conductive agent, wherein the conductive agent has a specific surface area (BET) of 60 m²/g to 1500 m²/g; and
a second layer comprising an active material, wherein the second layer is provided on at least one surface of the current collector, and the first layer is provided between the current collector and the second layer.

2. The electrochemical apparatus according to claim 1, wherein based on a total mass of the first layer, a mass percentage of the conductive agent is 50% to 80%.

3. The electrochemical apparatus according to claim 1, wherein a ratio of an orthographic projection area of the first layer on a surface of the current collector to an area of the current collector is 30% to 100%.

4. The electrochemical apparatus according to claim 1, wherein a surface roughness (Ra) of the first layer is 0.5 μm to 1.5 μm.

5. The electrochemical apparatus according to claim 1, wherein a single-side thickness T of the first layer is 0.2 μm to 1 μm.

6. The electrochemical apparatus according to claim 1, wherein the electrochemical apparatus satisfies at least one of the following conditions:
the conductive agent comprises one or more selected from the group consisting of conductive carbon black, Ketjen black, acetylene black, conductive graphite, graphene, carbon nanotubes, and carbon fiber;
the first layer further comprises a binder, the binder comprising one or more selected from the group consisting of polyacrylic acid, polyacrylate, polymethacrylic acid, polyacrylamide, polymethacrylamide, polymethacrylate, polyvinyl alcohol, and sodium alginate;
the first layer further comprises a dispersant, the dispersant comprising at least one of lithium carboxymethyl cellulose or sodium carboxymethyl cellulose.

7. The electrochemical apparatus according to claim 1, wherein a median particle size D₅₀ of particles of the conductive agent in the first layer and a thickness T of the first layer satisfy that T is within a range of 2×D₅₀ to 5×D₅₀.

8. The electrochemical apparatus according to claim 1, wherein an areal density of the first layer is 0.03 mg/cm² to 0.3 mg/cm².

9. The electrochemical apparatus according to claim 6, wherein a weight-average molecular weight of the binder is 10,000 to 500,000.

10. The electrochemical apparatus according to claim 6, wherein based on a total mass of the first layer, a mass percentage of the binder is 10% to 48%.

11. The electrochemical apparatus according to claim 6, wherein based on a total mass of the first layer, a mass percentage of the dispersant is 1% to 10%.

12. An electronic apparatus, comprising an electrochemical apparatus, the electrochemical apparatus comprises an electrode plate, wherein the electrode plate comprises:
a current collector;
a first layer comprising a conductive agent, wherein the conductive agent has a specific surface area (BET) of 60 m²/g to 1500 m²/g; and
a second layer comprising an active material, wherein the second layer is provided on at least one surface of the current collector, and the first layer is provided between the current collector and the second layer.

13. The electronic apparatus according to claim 12, wherein based on a total mass of the first layer, a mass percentage of the conductive agent is 50% to 80%.

14. The electronic apparatus according to claim 12, wherein a ratio of an orthographic projection area of the first layer on a surface of the current collector to an area of the current collector is 30% to 100%.

15. The electronic apparatus according to claim 12, wherein a surface roughness (Ra) of the first layer is 0.5 μm to 1.5 μm.

16. The electronic apparatus according to claim 12, wherein a single-side thickness T of the first layer is 0.2 μm to 1 μm.

17. The electrochemical apparatus according to claim 12, wherein the electrochemical apparatus satisfies at least one of the following conditions:
the conductive agent comprises one or more selected from the group consisting of conductive carbon black, Ketjen black, acetylene black, conductive graphite, graphene, carbon nanotubes, and carbon fiber;
the first layer further comprises a binder, the binder comprising one or more selected from the group consisting of polyacrylic acid, polyacrylate, polymethacrylic acid, polyacrylamide, polymethacrylamide, polymethacrylate, polyvinyl alcohol, and sodium alginate;
the first layer further comprises a dispersant, the dispersant comprising at least one of lithium carboxymethyl cellulose or sodium carboxymethyl cellulose.

18. The electronic apparatus according to claim 17, wherein a weight-average molecular weight of the binder is 10,000 to 500,000.

19. The electronic apparatus according to claim 17, wherein based on a total mass of the first layer, a mass percentage of the binder is 10% to 48%.

20. The electronic apparatus according to claim 17, wherein based on a total mass of the first layer, a mass percentage of the dispersant is 1% to 10%.
